(19) United States
(12) Patent Application Publication
(10) Pub. No.: US 2010/0199421 A1
(43) Pub. Date: Aug. 12, 2010

(54) SHOWER AND WASH APPARATUS USING MICRO BUBBLE

(75) Inventors: Hong Yeon Moon, Gyeonggi-do (KR); Shun Hwa Lee, Daegu (KR); Min Chul Kim, Gyeonggi-do (KR); Se Han Lee, Gyeongsangbuk-do (KR); Jung In Koo, Gyeonggi-do (KR)

Correspondence Address: OCCHIUTI ROHLICEK & TSAO, LLP, 10 FAWCETT STREET, CAMBRIDGE, MA, 02138, US

(73) Assignee: Robotous Co Ltd, Gyeonggi-do (KR)

(21) Appl. No.: 12/669,768

(22) PCT Filed: Oct. 30, 2008
(86) PCT No.: PCT/KR2008/006395

§ 371 Date: Jan. 19, 2010

(30) Foreign Application Priority Data
Oct. 31, 2007 (KR) 1020070110409
Oct. 10, 2008 (KR) 1020080099459

(51) Int. Cl. A47K 3/28; A62C 5/00

(52) U.S. Cl. 4/602; 239/311

(57) ABSTRACT

Provided is a shower. The shower is configured to form dissolved water in which gas is dissolved and configured to generate micro bubbles in the dissolved water, so as to provide shower water having a high wash efficiency and harmless to the human body. The shower includes a pressure tank, a service water supply tube having a front end directly connected to a water supply tube, and a rear end connected to an upper end of the pressure tank, the service water supply tube injecting a service water into the pressure tank, a dissolution tub disposed in the pressure tank and configured to mix the service water, injected by the service water supply tube, with a gas in the pressure tank, so as to generate a dissolved water, a dissolved water supply tube having a front end connected to a lower end of the pressure tank and providing a supply path of the dissolved water stored in the pressure tank, and a shower head coupled to a rear end of the dissolved water supply tube.

### TECHNICAL FIELD

The present invention relates to an apparatus using micro bubbles, and more particularly, to a shower and a wash apparatus using micro bubbles.

### BACKGROUND ART

Human skins, dishes, and vegetables have their own surface roughness, and water is one of materials having a relatively great surface tension.

FIG. 1 is an enlarged view illustrating contact state between water and a surface to be washed. Referring to FIG. 1, when a wash object 1 is washed using the water W, the surface tension of the water W prevents the water W from permeating into contaminants 1a remaining on a surface of the wash object 1, so that a wash efficiency thereof is decreased. Accordingly, a detergent containing a surface active agent is used to improve the wash efficiency. However, the related art detergent includes harmful chemicals to the human body.

Thus, wash apparatuses used without a detergent are recently developed. Such wash apparatuses include wash apparatuses using ultrasonic, far infrared ray and ozone.

The ultrasonic wash apparatus is configured to wash objects such as tableware and fruits in a wash container including wash water, with ultrasonic that is generated from a bottom of the wash container and strongly vibrates the wash water to form spray. However, in the case of such ultrasonic apparatuses, since waste water used for washing remains in a wash container, a wash object becomes dirty again. Thus, it is required to wash the wash object again with running water.

The far infrared ray wash apparatus is configured to wash object using infrared rays that have a wavelength of 25 μm or more and that are adapted to perform strong sympathetic vibration operation and resonance operation for organic compound molecules. The far infrared rays are generated by heating a material such as ocher, white oak charcoal, and white bamboo charcoal. However, material consumption for generating the far infrared rays, and energy consumption for heating the material are required to cause a financial burden.

The ozone wash apparatus is configured to wash an object using strong oxidizing power of ozone in ozone water supplied to a wash container. The ozone water is obtained by dissolving ozone into supplied wash water. However, ozone generated from Earth becomes harmful air pollutants to the human body.

### DISCLOSURE OF INVENTION

### Technical Problem

An object of the present invention is to provide a shower using shower water having a high wash efficiency and harmless to the human body.

Another object of the present invention is to provide a wash apparatus using wash water having a high wash efficiency and harmless to the human body.

### Technical Solution

In one embodiment, a shower includes: a pressure tank; a service water supply tube having a front end directly connected to a water supply tube, and a rear end connected to an upper end of the pressure tank, the service water supply tube injecting a service water into the pressure tank; a dissolution tub disposed in the pressure tank and configured to mix the service water, injected by the service water supply tube, with a gas in the pressure tank, so as to generate a dissolved water; a dissolved water supply tube having a front end connected to a lower end of the pressure tank and providing a supply path of the dissolved water stored in the pressure tank; and a shower head coupled to a rear end of the dissolved water supply tube.

In another embodiment, a wash apparatus includes: a pressure tank; a service water supply tube having a front end directly connected to a water supply tube, and a rear end connected to an upper end of the pressure tank, the service water supply tube injecting a service water into the pressure tank; a dissolution tub disposed in the pressure tank and configured to mix the service water, injected by the service water supply tube, with a gas in the pressure tank, so as to generate a dissolved water; a dissolved water supply tube having a front end connected to a lower end of the pressure tank and providing a supply path of the dissolved water stored in the pressure tank; and a water tap coupled to a rear end of the dissolved water supply tube.

### ADVANTAGEOUS EFFECTS

Shower water and wash water can be supplied, which are harmless to the human body and have a high clean and wash efficiency with low power consumption.

### BRIEF DESCRIPTION OF DRAWINGS

FIG. 1 is an enlarged view illustrating contact state between water and a surface to be washed.

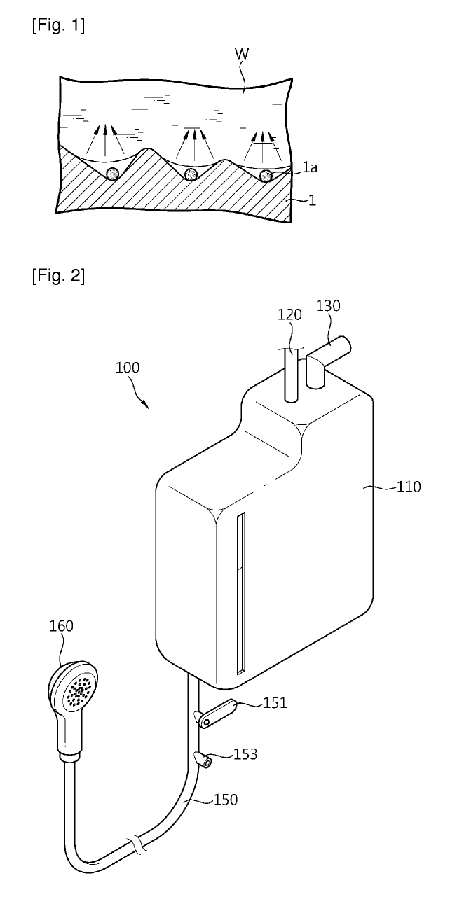

FIG. 2 is a perspective view illustrating a shower using micro bubbles according to an embodiment.

FIG. 3 is a cross-sectional view illustrating a shower using micro bubbles according to an embodiment.

FIGS. 4 through 6 are schematic views illustrating operation of a shower using micro bubbles according to an embodiment.

FIG. 7 is a cross-sectional view illustrating install state of a wash apparatus using micro bubbles according to an embodiment.

FIG. 8 is a perspective view illustrating a wash apparatus using micro bubbles according to an embodiment.

FIG. 9 is a cross-sectional view illustrating a wash apparatus using micro bubbles according to an embodiment.

FIGS. 10 and 11 are schematic views illustrating operation of a wash apparatus using micro bubbles according to an embodiment.

FIG. 12 is an enlarged view illustrating contact state between a surface to be washed and a wash water generated by a wash apparatus using micro bubbles according to an embodiment.

### DESCRIPTION OF THE SYMBOLS IN MAIN PORTIONS OF THE DRAWINGS

100: Shower Using Micro Bubbles
110: Pressure Tank
120: Intake Tube
130: Service Water Supply Tube
140: Dissolution Tub
150: Dissolved Water Supply Tube
160: Shower Head
200: Wash Apparatus Using Micro Bubbles
210: Compressor Pump
221, 222: Level Sensor
240: Water Tap

### MODE FOR THE INVENTION

Hereinafter, configuration of a shower using micro bubbles according to an embodiment will now be described with reference to the accompanying drawings.

First, service water and dissolved water are defined for convenience. The service water is defined as water supplied to a shower and a wash apparatus using micro bubbles. The service water includes water supplied at a predetermined pressure (e.g., 4 standard atmospheres or less on the supposition that the atmospheric pressure is 1 standard atmosphere) as well as water provided to houses. The dissolved water is water in which gas is dissolved.

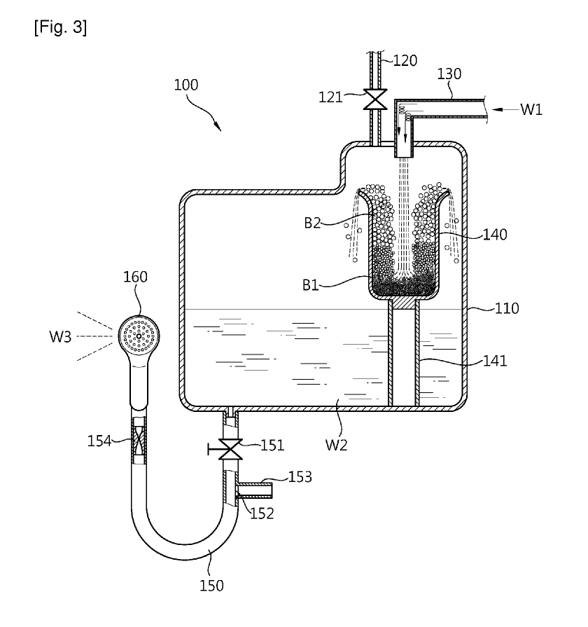

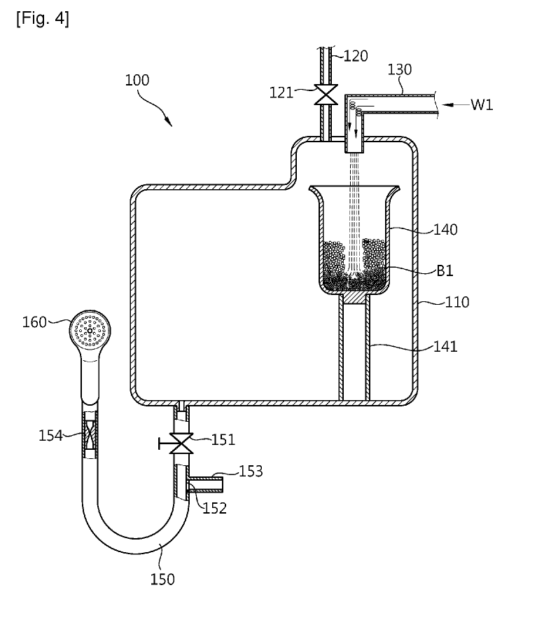

FIG. 2 is a perspective view illustrating the shower 100 using micro bubbles according to the embodiment. FIG. 3 is a cross-sectional view illustrating the shower 100 using micro bubbles according to the embodiment. Referring to FIGS. 2 and 3, the shower 100 using micro bubbles (hereinafter, referred to as a shower) includes a pressure tank 110, an intake tube 120, a service water supply tube 130, a dissolution tub 140, a dissolved water supply tube 150, and a shower head 160.

The pressure tank 110 defines a sealed inner space. The intake tube 120 is coupled to an upper end of the pressure tank 110. The intake tube 120 provides a path where outside gas is supplied into the pressure tank 110. A sluice valve 121 is provided to a line of the intake tube 120. The sluice valve 121 supplies or shuts off gas according to pressure state in the pressure tank 110. The sluice valve 121 may include a check valve that is configured to open the intake tube 120 when pressure in the pressure tank 110 is less than the atmospheric pressure, and to close the intake tube 120 when the pressure in the pressure tank 110 is greater than the atmospheric pressure.

A front end of the service water supply tube 130 is directly connected to a water supply tube (not shown) supplying a service water W1, and a rear end thereof is coupled to the upper end of the pressure tank 110. The service water supply tube 130 is bent in a perpendicular direction to a flow direction of the service water W1.

The dissolution tub 140 is disposed in the pressure tank 110. The dissolution tub 140 has a container shape, an upper end of which is opened and expands toward the service water supply tube 130. An axis of the dissolution tub 140 is the same as that of the service water supply tube 130. An upper outer surface of the dissolution tub 140 is spaced apart from an inner surface of the pressure tank 110, only to the extent where a bubble aggregation B2, that will be described later, can overflow from the dissolution tub 140.

A front end of the dissolved water supply tube 150 is coupled to a lower end of the pressure tank 110, and a rear end thereof is coupled to the shower head 160. The dissolved water supply tube 150 provides a supply path of a dissolved water W2 stored in the pressure tank 110. A line of the dissolved water supply tube 150 is provided with a supply valve 151, a path change valve 152, a dissolved water discharge tube 153, and a flow rate increase member 154.

The supply valve 151 is disposed at a downstream in the front end of the dissolved water supply tube 150. The supply valve 151 closes the dissolved water supply tube 150 to seal the pressure tank 110. The supply valve 151 opens the dissolved water supply tube 150 to discharge the dissolved water W2 from the pressure tank 110 to the dissolved water supply tube 150.

The path change valve 152 is disposed on a path of the dissolved water W2 leaving the supply valve 151, to direct the dissolved water W2 to a first path or a second path. That is, the path change valve 152 guides the dissolved water W2 to the shower head 160 or the dissolved water discharge tube 153. The dissolved water discharge tube 153 extends out of the dissolved water supply tube 150 to provide a discharge path of the dissolved water W2. The path change valve 152 may include a 3-way valve.

The flow rate increase member 154 is disposed at a downstream of the path change valve 152. The flow rate increase member 154 quickly increases a flow rate of the dissolved water W2 toward the shower head 160. The flow rate increase member 154 quickly decreases in cross section from a front end thereof, and has the minimum cross section at a middle thereof, and gradually increases in cross section at a rear end thereof. The flow rate increase member 154 may include any one of a nozzle and a venturi tube applying a shearing force to the dissolved water W2.

The shower head 160 is configured to spray a dissolved water W3 including micro bubbles, leaving the venturi tube 154.

Hereinafter, operation of the shower using micro bubbles according to an embodiment will now be described with reference to the accompanying drawings.

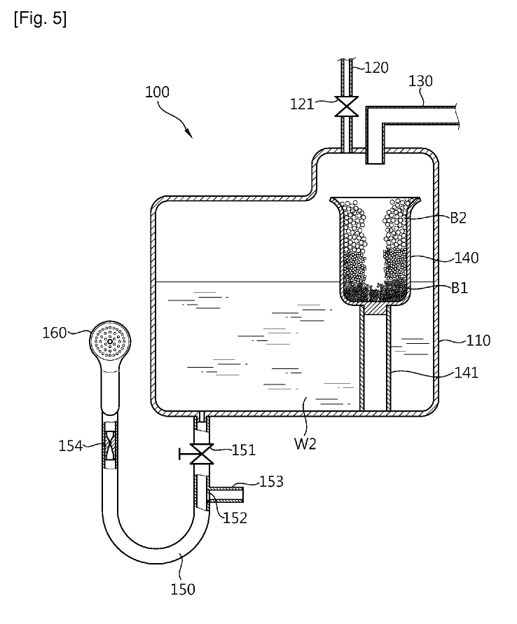

FIGS. 4 through 6 are schematic views illustrating the operation of the shower with micro bubbles according to the embodiment.

Referring to FIG. 4, before the service water W1 is supplied to the pressure tank 110, the pressure in the pressure tank 110 may be less than the atmospheric pressure. The sluice valve 121 opens the intake tube 120 to introduce gas into the pressure tank 110.

The service water W1 is supplied through the water supply tube (not shown), and then travels to the service water supply tube 130. The service water W1 collides on a vertically bent wall of the service water supply tube 130, and turbulence occurs in the service water W1. Flow rate of the dissolved water W1 increases and the dissolved water W1 vertically falls to the pressure tank 110. At this point, as the service water W1 is supplied to the pressure tank 110, the pressure in the pressure tank 110 increases to be greater than the atmospheric pressure. The sluice valve 121 closes the intake tube 120 to prevent the gas in the pressure tank 110 from going out of the pressure tank 110.

The service water W1, wrapping the gas in the pressure tank 110, falls to the dissolution tub 140. The service water W1 generates bubbles B1 in the dissolution tub 140. Buoyancy raises the bubbles B1 along an inner wall of the dissolution tub 140. As the service water W1 is continuously supplied, the amount of the bubbles B1 quickly increases.

Then, referring to FIG. 5, the great amount of the bubbles B2 are collected to form the bubble aggregation B2. The bubble aggregation B2 overflowing from the dissolution tub 140 is stored as the dissolved water W2 in the pressure tank 110. A level of the dissolved water W2 in the pressure tank 110 gradually increases.

The increased level of the dissolved water W2 and a supply pressure of the service water W1 compresses the gas in the pressure tank 110 to a predetermined pressure. Also, the level of the dissolved water W2 increases until the pressure in the pressure tank 110 is the same as the supply pressure of the service water W1. At this point, the level of the dissolved water W2 (hereinafter, a warning level), where the pressure in the pressure tank 110 is the same as the supply pressure of the service water W1, may vary according to the supply pressure of the service water W1. That is, as the supply pressure of the service water W1 increases, the warning level increases. On the contrary, as the supply pressure of the service water W1 decreases, the warning level decreases.

As such, when the dissolved water W2 reaches the warning level, the supplying of the service water W1 is stopped and the supply valve 151 is opened. The dissolved water W2 passes through the supply valve 151 and reaches the path change valve 152. The path change valve 152 guides the dissolved water W2 to the shower head 160. The flow rate of the dissolved water W2 traveling to the shower head 160 increases when passing through the flow rate increase member 154. In this case, the dissolved water W2 is released immediately to the atmospheric pressure, so that the dissolved water W2 is degassed to generate micro bubbles. The dissolved water W3 including the micro bubbles is sprayed through the shower head 160.

When the dissolved water W3 is sprayed through the shower head 160, the pressure in the pressure tank 110 gradually decreases. When the pressure in the pressure tank 110 decreases below the atmospheric pressure, the sluice valve 121 opens the intake tube 120 to introduce gas into the pressure tank 110.

Then, referring to FIG. 6, when a user finishes his/her shower, the dissolved water W2 remaining in the pressure tank 110 may be discharged to the outside. That is, the user opens the supply valve 151, and turns the path change valve 152 to the dissolved water discharge tube 153, so that the remaining dissolved water W2 is discharged to the outside.

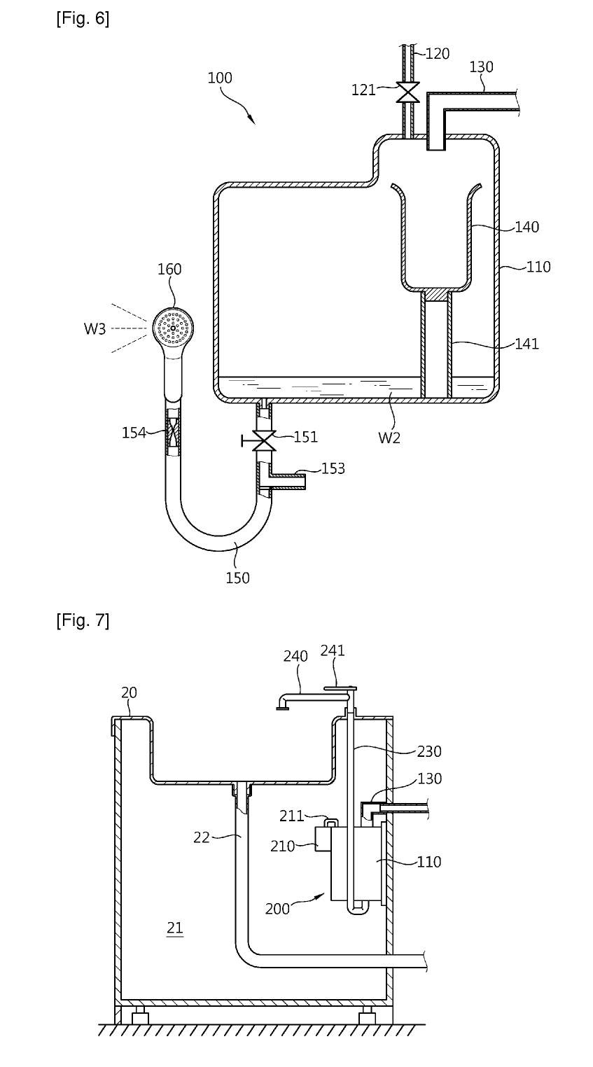

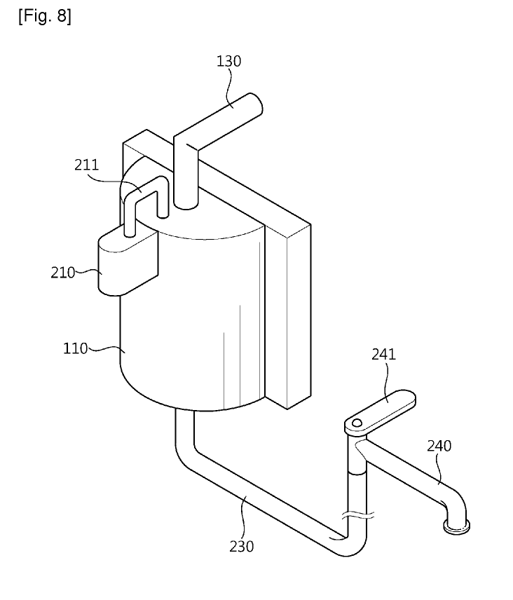

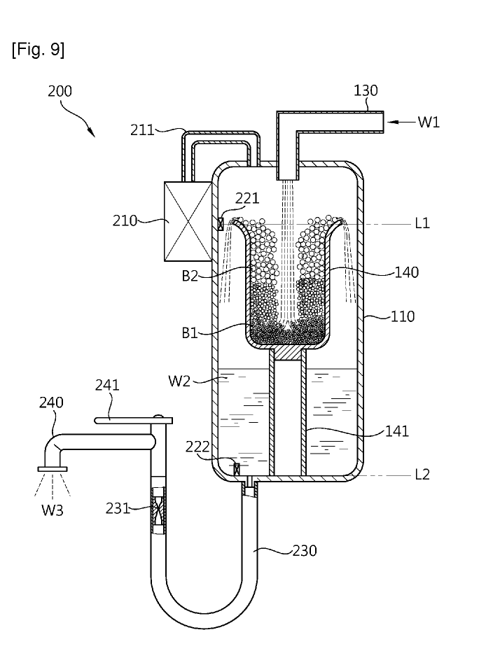

Hereinafter, a wash apparatus using micro bubbles will now be described according to an embodiment. FIG. 7 is a cross-sectional view illustrating install state of the wash apparatus 200 using micro bubbles according to the embodiment. FIG. 8 is a perspective view illustrating the wash apparatus 200 using micro bubbles according to the embodiment. FIG. 9 is a cross-sectional view illustrating the wash apparatus 200 using micro bubbles according to the embodiment.

Referring to FIGS. 7 through 9, a sink 20 is a stand configured to receive or discharge water while washing dishes or foods at a kitchen. A lower portion of the sink 20 is provided with a storage 21 for storing dishes and pans. The sink 20 is provided with a drain tube 22 for discharging waste water used for washing

The wash apparatus 200 using micro bubbles (hereinafter, a wash apparatus) includes a pressure tank 110, a compressor pump 210, level sensors 221 and 222, a service water supply tube 130, a dissolution tub 140, a dissolved water supply tube 230, and a water tap 240. The components of the wash apparatus 200 except for the tap 240 may be stored in the storage 21, thereby protecting the wash apparatus 200 against damage from the outside of the sink 20, and improving space availability on an upper side of the sink 20.

Configuration and operation of the pressure tank 110, the service water supply tube 130, and the dissolution tub 140 in the wash apparatus 200 is similar to those of the pressure tank 110, the service water supply tube 130, and the dissolution tub 140 in the aforementioned shower 100. Thus, the pressure tank 110, the service water supply tube 130, and the dissolution tub 140 in the wash apparatus 200 have the same reference numerals as those of the pressure tank 110, the service water supply tube 130, and the dissolution tub 140 in the shower 100, and thus detailed description thereof is omitted here. The components, the detailed description of which is omitted, will be appreciated with reference to the previous description.

The compressor pump 210 is disposed out of the pressure tank 110. The compressor pump 210 is connected to the pressure tank 110 through an intake tube 211. The intake tube 211 provides a supply path of gas supplied into the pressure tank 110 by the compressor pump 210.

The level sensors 221 and 222 are disposed between an upper limit line L1 and a lower limit line L2 of a dissolved water W2. The upper limit line L1 is the maximum level of the dissolved water W2 for the dissolved water W2 stored in the pressure tank 110 not to flow backward to the dissolution tub 140. The lower limit line L2 is the minimum level of the dissolved water W2 for gas in the pressure tank 110 not to be discharged together with the dissolved water W2 through the dissolved water supply tube 230.

A rear end of the dissolved water supply tube 230 is connected to the water tap 240 and provided with a flow rate increase member 231 that quickly increases the flow rate of the dissolved water W2 toward the water tap 240.

The water tap 240 includes a supply valve 241 opening the dissolved water supply tube 230 to discharge a dissolved water W3 including micro bubbles to the sink 20.

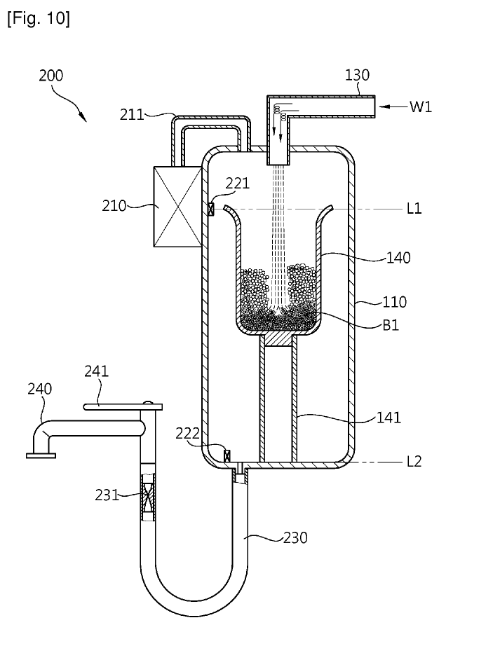

Hereinafter, operation of the wash apparatus 200 using micro bubbles, according to an embodiment will now be described in detail with reference to the accompanying drawings. FIGS. 10 and 11 are schematic views illustrating the operation of the wash apparatus 200 using micro bubbles according to this embodiment.

First, referring to FIG. 10, before the service water W1 is supplied to the pressure tank 110, a predetermined amount of gas is present at the atmospheric pressure in the pressure tank 110. The service water W1 is supplied through a water supply tube (not shown), and then travels to the service water supply tube 130. The service water W1 collides on a vertically bent wall of the service water supply tube 130, and turbulence occurs in the service water W1. Flow rate of the service water W1 increases and the service water W1 vertically falls to the pressure tank 110.

The service water W1, wrapping the gas in the pressure tank 110, falls to the dissolution tub 140. The service water W1 generates bubbles B1 in the dissolution tub 140. Buoyancy raises the bubbles B1 along an inner wall of the dissolution tub 140. As the service water W1 is continuously supplied, the amount of the bubbles B1 quickly increases.

Then, referring to FIG. 11, the great amount of the bubbles B1 are collected to form a bubble aggregation B2. The bubble aggregation B2 overflowing from the dissolution tub 140 is stored as the dissolved water W2 in the pressure tank 110. The level of the dissolved water W2 in the pressure tank 110 gradually increases. The increased level of the dissolved water W2 and a supply pressure of the service water W1 compress the gas in the pressure tank 110 to a predetermined pressure. A predetermined amount of the gas is efficiently dissolved, and the level of the dissolved water W2 reaches the upper limit line L1. When the level of the dissolved water W2 reaches the upper limit line L1, the pressure in the pressure tank 110 is the same as the supply pressure of the service water W1.

At this point, the supplying of the service water W1 is stopped, and the supply valve 241 of the water tap 240 is opened. The flow rate of the dissolved water W2 traveling to the water tap 240 increases while passing through the flow rate increase member 231. In this case, the dissolved water W2 is released immediately to the atmospheric pressure, so that the dissolved water W2 is degassed to generate micro bubbles. The dissolved water W3 including the micro bubbles is supplied to the sink 20 through the water tap 240.

As the dissolved water W2 is supplied to the sink 20, the pressure in the pressure tank 110 gradually decreases, and the gas in the pressure tank 110 is dissolved, so that the amount of the gas is gradually reduced. The compressor pump 210 pumps gas into the pressure tank 110 to prevent the gas in the pressure tank 110 from being completely consumed.

That is, the level sensors 221 and 222 detect the level of the dissolved water W2 that have reached the upper limit line L1. The compressor pump 210 injects gas into the pressure tank 110 through the intake tube 211. The dissolved water W3 is continuously supplied to the sink 20, and the level sensors 221 and 222 detect the level of the dissolved water W2 that have reached the lower limit line L2. The compressor pump 210 stops the injecting of the gas. As such, the wash apparatus 200 detects the level of the dissolved water W2 through the level sensors 221 and 222, and the compressor pump 210 injects the gas into the pressure tank 110, so as to assure the continuous operation of the wash apparatus 200.

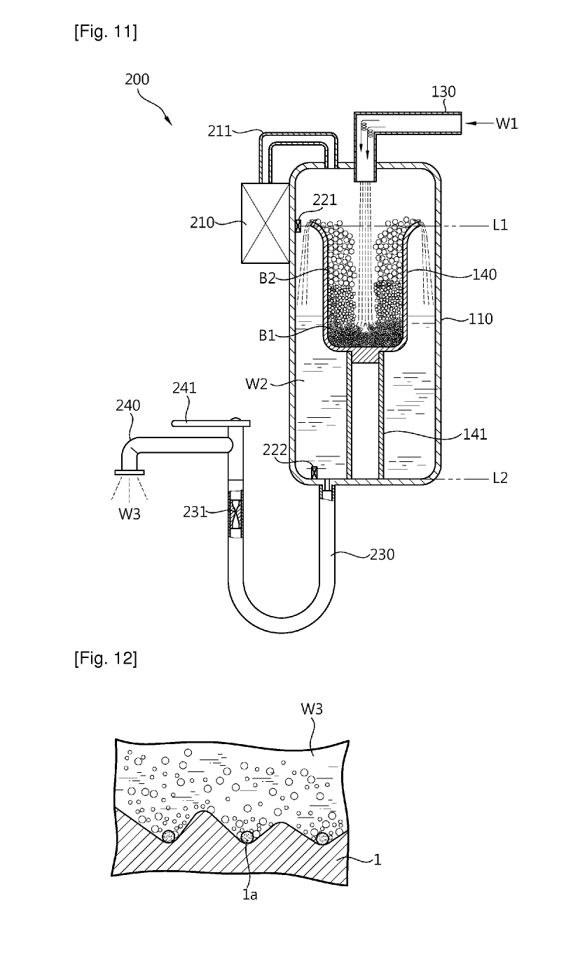

FIG. 12 is an enlarged view illustrating contact state between a surface to be washed and the wash water W3 generated by the wash apparatus 200 using micro bubbles according to an embodiment. Referring to FIG. 12, the dissolved water W3 discharged through the water tap 240 includes a great amount of micro bubbles. The dissolved water W including the micro bubbles is used for washing a wash object 1.

As described above, the wash object 1 includes contaminants because of surface roughness of the wash object 1. However, the abundant micro bubbles, included in the dissolved water W3, break the surface tension of the dissolved water W3, and the abundant micro bubbles are so fine to permeate into contaminants 1a remaining on the surface of the wash object 1, so as to efficiently remove the contaminants 1a remaining on the wash object 1.

As such, the wash apparatus 200 generates the dissolved water W2, in which gas is dissolved, from the service water W1, and generates micro bubbles in the dissolved water W2, and uses the dissolved water W3, including the micro bubbles in large quantities, as a wash water, thereby improving a wash efficiency for the wash object 1 with small power consumption.

A wash efficiency of wash water generated by the wash apparatus 200 is similar to that of wash water generated by the shower 100.

Although not shown, according to another embodiment, the shower 100 may include the compressor pump 210 and the level sensors 211 and 222 included in the wash apparatus 200. The shower 100, including the compressor pump 210 and the level sensors 211 and 222, supplies a predetermined amount of gas into the pressure tank 110 according to the level of the dissolved water W2. In the case where the shower 100 includes the compressor pump 210 and the level sensors 211 and 222, the sluice valve 121 disposed on the line of the intake tube 120 may be omitted.

1. A shower comprising:
a pressure tank;
a service water supply tube having a front end directly connected to a water supply tube, and a rear end connected to an upper end of the pressure tank, the service water supply tube injecting a service water into the pressure tank;
a dissolution tub disposed in the pressure tank and configured to mix the service water, injected by the service water supply tube, with a gas in the pressure tank, so as to generate a dissolved water;
a dissolved water supply tube having a front end connected to a lower end of the pressure tank and providing a supply path of the dissolved water stored in the pressure tank; and
a shower head coupled to a rear end of the dissolved water supply tube.

2. The shower of claim 1, further comprising an intake tube coupled to the upper end of the pressure tank and supplying an outside gas into the pressure tank.

3. The shower of claim 2, further comprising a sluice valve disposed on a line of the intake tube,
wherein the sluice valve, according to pressure state in the pressure tank, opens the intake tube to supply the outer gas into the pressure tank and closes the intake tube to prevent the gas in the pressure tank from going out of the pressure tank.

4. The shower of claim 1, further comprising:
a supply valve disposed on a line of the dissolved water supply tube and controlling quantity of flow of the dissolved water;
a flow rate increase member disposed on a first path thorough which the dissolved water leaving the supply valve goes toward the shower head, the flow rate increase member increasing a flow rate of the dissolved water;
a dissolved water discharge tube configured to discharge the dissolved water leaving the supply valve to a second path different from the first path; and
a path change valve disposed at a position where the first and second paths meet each other and changing a path of the dissolved water to the first path or the second path.

5. The shower of claim 1, wherein the service water supply tube drops the service water, supplied through the water supply tube, in a perpendicular direction to a supply direction of the service water.

6. The shower of claim 1, further comprising:
a compressor pump disposed out of the pressure tank; and
an intake tube connecting the compressor pump to the pressure tank and providing a supply path of a gas supplied into the pressure tank by the compressor pump.

7. The shower of claim 6, further comprising a level sensor detecting a level of the dissolved water stored in the pressure tank.

8. The shower of claim 7, wherein the level sensor detects a maximum level of the dissolved water for the dissolved water not to overflow from an upper end of the dissolution tub, and
detects a minimum level of the dissolved water for the gas in the pressure tank not to be discharged through the dissolved water supply tube.

9. A wash apparatus comprising:
a pressure tank;
a service water supply tube having a front end directly connected to a water supply tube, and a rear end connected to an upper end of the pressure tank, the service water supply tube injecting a service water into the pressure tank;
a dissolution tub disposed in the pressure tank and configured to mix the service water, injected by the service water supply tube, with a gas in the pressure tank, so as to generate a dissolved water;
a dissolved water supply tube having a front end connected to a lower end of the pressure tank and providing a supply path of the dissolved water stored in the pressure tank; and
a water tap coupled to a rear end of the dissolved water supply tube.

10. The wash apparatus of claim 9, further comprising:
a compressor pump disposed out of the pressure tank; and
an intake tube connecting the compressor pump to the pressure tank and providing a supply path of a gas supplied into the pressure tank by the compressor pump.

11. The wash apparatus of claim 10, further comprising a level sensor detecting a level of the dissolved water stored in the pressure tank.

12. The wash apparatus of claim 11, wherein the level sensor detects a maximum level of the dissolved water for the dissolved water not to overflow from an upper end of the dissolution tub, and
detects a minimum level of the dissolved water for the gas in the pressure tank not to be discharged through the dissolved water supply tube.

13. The wash apparatus of claim 9, further comprising a flow rate increase member disposed on a line of the dissolved water supply tube and increasing a flow rate of the dissolved water.

14. The wash apparatus of claim 9, wherein the service water supply tube drops the service water, supplied through the water supply tube, in a perpendicular direction to a supply direction of the service water.
